(19) United States
(12) Patent Application Publication
(10) Pub. No.: US 2024/0058751 A1
(43) Pub. Date: Feb. 22, 2024

(54) SULPHUR TOLERANCE IN Cu-SCR CATALYSTS

(71) Applicant: Johnson Matthey Public Limited Company, London (GB)

(72) Inventors: Kaneshalingam ARULRAJ, Royston (GB); Daniel Robert AVIS, Royston (GB); Guy Richard CHANDLER, Royston (GB); Alexander Nicholas Michael GREEN, Royston (GB); Matthew Eben HARRIS, Royston (GB); Oliver HEMMING, Billingham (GB); Carmelo IACONO, Reading (GB); Alanna Susan MURPHY, Royston (GB); Paul Richard PHILLIPS, Royston (GB); Maria Pia RUGGERI, Reading (GB)

(21) Appl. No.: 18/355,425

(22) Filed: Jul. 20, 2023

Related U.S. Application Data
(60) Provisional application No. 63/369,714, filed on Jul. 28, 2022.

(51) Int. Cl. B01D 53/56; F01N 3/20; B01J 29/72

(52) U.S. Cl. CPC B01D 53/565; F01N 3/2066; B01J 29/723; B01D 2258/01; B01D 2257/404; B01J 2220/42; B01J 2229/20

(57) ABSTRACT

The present invention relates to a catalyst composition. More particularly, the present invention relates to a catalyst composition comprising a low SAR zeolite, copper in an amount of at least 2 wt %; and a rare earth element. The present invention also relates to a method for the manufacture of a catalyst composition. The present invention further relates to a catalyst article comprising a catalyst composition and a method for the treatment of an exhaust gas which comprises contacting an exhaust gas with a catalyst article comprising a catalyst composition.

### FIELD OF THE INVENTION

The present invention relates to a catalyst composition. More particularly, the present invention relates to a catalyst composition comprising a low SAR zeolite, copper in an amount of at least 2 wt %; and a rare earth element. The present invention also relates to a method for the manufacture of a catalyst composition. The present invention further relates to a catalyst article comprising a catalyst composition and a method for the treatment of an exhaust gas which comprises contacting an exhaust gas with a catalyst article comprising a catalyst composition.

### BACKGROUND OF THE INVENTION

Selective catalytic reduction (SCR) is the most effective technique for NOx abatement in lean-burning engine exhaust after-treatment. This SCR technique refers to a technique in which a reducing agent or a reducing substance in an exhaust gas selectively reduces NOx to N₂ under the action of a catalyst to avoid a non-selective oxidation reaction of a reducing agent. Copper zeolites have been commercialized as SCR catalysts for their significant advantages of excellent catalytic performance and hydrothermal stability.

However, many SCR catalysts can be neutralized, deactivated, or experience reduced effectiveness when exposed to sulfur compounds over time. The deactivation by sulfur over time is an accumulative process, limiting the effective life of the catalytic component, or requiring periodic removal of the sulfur compounds.

The presence of sulfur decreases the efficiency of various components in the exhaust aftertreatment system. Presently known sulfur removal processes require exposing the SCR catalyst to very high temperatures, which may significantly impact fuel economy, performance of the engine, and expose the other exhaust aftertreatment system components to increased aging. Therefore, a need remains for further improvements in compositions and methods for SCR aftertreatment systems.

Previous work has also found that the stability of the catalyst is detrimentally affected by the use of a zeolite with a low SAR and/or copper incorporation into the catalyst.

The present inventors have surprisingly found that the combination of a low SAR zeolite with a high copper loading affords vastly improved sulfur tolerance in comparison to previous formulations, without affecting the stability of the catalyst. The addition of a rare earth element can further improve the sulfur tolerance, hydrothermal ageing, and the stability of the catalyst.

### SUMMARY OF THE INVENTION

One aspect of the present disclosure is directed to a catalyst composition comprising:
a) a low SAR zeolite;
b) copper in an amount of at least 2 wt %; and
c) a rare earth element.

Another aspect of the present disclosure is directed to a method of preparing a catalyst composition (i.e. the catalyst composition as herein described), said method comprising:
(i) incorporating copper into a zeolite through ion exchange to prepare a copper-substituted zeolite, and
(ii) incorporating a rare earth element into the copper-substituted zeolite.

Another aspect of the present disclosure is directed to a catalyst article for the treatment of an exhaust gas, the catalyst article comprising the catalyst composition as described herein.

Another aspect of the present disclosure is directed to an exhaust gas system comprising the catalyst article as described herein.

Another aspect of the present disclosure is directed to a method for the treatment of an exhaust gas, the method comprising contacting an exhaust gas with the catalyst article described herein.

### BRIEF DESCRIPTION OF THE DRAWINGS

FIG. 1 shows the effect of adding ceria to various copper-zeolite catalysts

FIG. 2 shows the Cu SCR sulfur ageing with various different catalyst compositions

### DETAILED DESCRIPTION OF THE INVENTION

A first aspect of the present invention is directed to a catalyst composition comprising:
a) a low SAR zeolite;
b) copper in an amount of at least 2 wt %; and
c) a rare earth element.

The present disclosure will now be described further. In the following passages, different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

### Zeolite

Catalyst compositions of the present invention include at least one zeolite. Zeolites are structures formed from alumina and silica and the SAR determines the reactive sites within the zeolite structure. Zeolites useful for the present invention may comprise a small pore zeolite (e.g. a zeolite having a maximum ring size of eight tetrahedral atoms), a medium pore zeolite (e.g. a zeolite having a maximum ring size of ten tetrahedral atoms), a large pore zeolite (e.g. a zeolite having a maximum ring size of twelve tetrahedral atoms), or a combination of two or more thereof.

When the catalyst composition comprises a small pore zeolite, then the small pore zeolite may have a framework structure represented by a Framework Type Code (FTC) selected from the group comprising (e.g. consisting of) ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, LTA, KFI, MER, MON, NSI, OWE, PAU, PHI, RHO, RTH, SAT, SAV, SFW, SIV, THO, TSC, UEI, UFI, VNI, YUG and ZON, or a mixture and/or combination and/or an intergrowth of two or more thereof. In some embodiments, the small pore zeolite has a framework structure selected from the group comprising (e.g. consisting of) CHA, LEV, AEI, AFX, ERI, LTA, SFW, KFI, DDR and ITE. In some embodiments, the small pore zeolite has a framework structure selected from the group comprising (e.g. consisting of) CHA and AEI. The small pore zeolite may have a CHA framework structure.

When the catalyst composition comprises a medium pore zeolite, then the medium pore zeolite may have a framework structure represented by a Framework Type Code (FTC) selected from the group comprising (e.g. consisting of) AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, PAR, PCR, PON, PUN, RRO, RSN, SFF, SFG, STF, STI, STT, STW, SVR, SZR, TER, TON, TUN, UOS, VSV, WEI and WEN, or a mixture and/or an intergrowth of two or more thereof. In some embodiments, the medium pore zeolite has a framework structure selected from the group comprising (e.g. consisting of) FER, MEL, MFI, and STT. In some embodiments, the medium pore zeolite has a framework structure selected from the group comprising (e.g. consisting of) FER and MFI, particularly MFI. When the medium pore zeolite has a FER or MFI framework, then the zeolite may be ferrierite, silicalite or ZSM-5.

When the catalyst composition comprises a large pore zeolite, then the large pore zeolite may have a framework structure represented by a Framework Type Code (FTC) selected from the group comprising (e.g. consisting of) AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, RON, RWY, SAF, SAO, SBE, SBS, SBT, SEW, SFE, SFO, SFS, SFV, SOF, SOS, STO, SSF, SSY, USI, UWY, and VET, or a mixture and/or an intergrowth of two or more thereof. In some embodiments, the large pore zeolite has a framework structure selected from the group comprising (e.g. consisting of) AFI, BEA, MAZ, MOR, and OFF. In some embodiments, the large pore zeolite has a framework structure selected from the group comprising (e.g. consisting of) BEA, MOR and FAU. When the large pore zeolite has a framework structure of FTC BEA, FAU or MOR, then the zeolite may be a beta zeolite, faujasite, zeolite Y, zeolite X or mordenite.

Catalyst compositions of the present invention preferably include a zeolite with low SAR. As used herein, low SAR may be understood to mean zeolites with a molar silica to alumina ratio (SAR) of between 10 and 30, more preferably about 10 to about 25, for example about 10 to about 22, from about 11 to 21, from about 11 to about 20, from about 11 to about 18, from about 12 to about 15, from about 10 to about 13, from about 10 to about 14, and from about 12 to about 14. The silica-to-alumina ratio of zeolites may be determined by conventional analysis. This ratio is meant to represent, as closely as possible, the ratio in the rigid atomic framework of the zeolite crystal and to exclude silicon or aluminum in the binder or in cationic or other form within the channels. Since it may be difficult to directly measure the silica to alumina ratio of zeolite after it has been combined with a binder material, particularly an alumina binder, these silica-to-alumina ratios are expressed in terms of the SAR of the zeolite per se, i.e., prior to the combination of the zeolite with the other catalyst components.

It has been surprisingly found that a zeolite with a low SAR can be used without affecting the stability of the resulting catalyst. The combination of a zeolite with low SAR with the claimed copper loadings and rare earth element incorporation has been found to have improved sulfur tolerance and hydrothermal ageing.

### Copper

Catalyst compositions of the present invention also include copper. In some embodiments, the copper is incorporated into the zeolite, for example, through ion exchange. The copper can be present in the catalyst composition in an amount of at least 2 wt %, at least 2.5 wt %, at least 3 wt %, at least 3.5 wt %, at least 4 wt %, or at least 4.5 wt %. The copper can be present in the catalyst composition in an amount of from about 1 to about 6 wt %, about 2 to about 5.5 wt %, e.g. from about 3 to about 5.4 wt %, from about 4 to about 5.3 wt %, from about 4.5 to about 5.2 wt %, from about 4.6 to about 5.1 wt %, or about about 4.7 to about 5 wt %. In some embodiments, copper is present in the catalyst composition in an amount of about 4 wt %, about 4.5 wt %, about 4.75 wt %, about 5 wt %, about 5.25 wt %, or about 5.5 wt %. The reference to wt % is based the weight of the zeolite.

Incorporation of copper into the catalyst composition has been surprisingly found to improve the performance of the catalyst without reducing the stability of the catalyst. Use of copper in combination with a rare earth element has been found to improve sulfur tolerance and hydrothermal ageing whilst also improving the performance of the catalyst without reducing the stability of the catalyst, even when a low SAR zeolite is used.

### Rare Earth Elements

Catalyst compositions of the present invention contain one or more rare earth elements. Preferably, the one or more rare earth elements are selected from the group comprising (e.g. consisting of) La, Ce, Pr, Nd, Sm, Eu, Gd, Tb, Dy, Ho, Er, Tm, Yb, Lu, Y, and Sc, including combinations of two or more thereof. In a particular embodiment, a rare earth element comprises Ce, Y, Zr, Mn, Fe, La, Nd, and Nb. In some aspects, the rare earth element is Ce.

The rare earth element content of the catalyst composition by weight preferably comprises from about 2 to about 5 wt %; about 2.5 to about 4.8 wt %; about 3 to about 4.5 wt %; about 3.5 to 4.4 wt %; about 2.75 wt % to about 4.4 wt %. The reference to wt % is based on the weight of the zeolite.

Incorporation of a rare earth element has been found to improve the sulfur tolerance and hydrothermal ageing, even when the SAR of the zeolite is low.

### Method of Preparation

A further aspect of the present invention is directed to a method of preparing a catalyst composition (e.g. a catalyst composition as described herein), said method comprising:
(i) incorporating copper into a zeolite to prepare a copper-substituted zeolite, and
(ii) incorporating a rare earth element into the copper-substituted zeolite.

Copper can be incorporated into the zeolite by methods known in the art. For example, ion exchange, spray drying, and cold one pot. The ion exchange may be conducted by blending the zeolite into a solution containing soluble precursors of copper (e.g. copper acetate or copper carbonate). The pH of the solution may be adjusted to induce precipitation of copper ions onto or within the zeolite structure. For example, a zeolite is immersed in a solution containing a soluble precursor of copper (e.g. copper acetate or copper carbonate) for a time sufficient to allow incorporation of the copper ions into the molecular sieve structure by ion exchange. Unexchanged copper ions can be precipitated out. Depending on the application, a portion of the unexchanged copper ions can remain in zeolite material as free metals. The copper-substituted zeolite may then be washed, dried and calcined. In a preferred alternative embodiment, the copper-substituted zeolite is used directly in a second step to incorporate a rare earth element.

Generally, ion exchange of the copper into or on the zeolite may be carried out at room temperature or at a temperature up to about 100° C., up to about 90° C., up to about 80° C., or up to about 70° C. For example, ion exchange can be carried out at a temperature of from 15 to 90° C., e.g. from 18 to 80° C., from 20 to 70° C., from 21 to 50° C., from 22 to 40° C., or from 25 to 30° C. Ion exchange can be performed over a period of about 1 to 24 hours, e.g. from 2 to 22 hours, from 3 to 20 hours, from 4 to 15 hours, or from 5 to 10 hours. Ion exchange can be performed at a pH of less than 9, e.g. less than 8, less than 7, less than 6, less than 5, less than 4 or less than 3. In a preferred example the pH of the ion exchange is between 2 and 5 or between 3 and 4. The resulting copper-substituted zeolite material is preferably used directly in a second step to incorporate a rare earth element. In an alternative embodiment, the resulting copper-substituted zeolite is dried at about 100 to 120° C. In some embodiments, the copper-substituted zeolite material is dried for 5 to 20 hours, e.g. from 8 to 18 hours, e.g. from 10 to 15 hours. The copper-substituted zeolite material can then be calcined at a temperature of at least about 550° C.

Copper may be present as an extra-framework metal, which is one that resides within the zeolite and/or on at least a portion of the zeolite surface.

Copper may be present as a counter-ion at the ion exchange sites of the framework structure.

Copper can be incorporated into the zeolite separately from the incorporation of the rare earth element(s). Methods of preparing a catalyst composition may include incorporating the rare earth element(s) and incorporating the copper in a separate process, either before or after incorporation of the rare earth element(s). In an alternative embodiment, copper can be incorporated into the zeolite at the same time as the rare earth element(s).

The rare earth element(s) (e.g. rare earth element(s) as described herein) may be incorporated into the zeolite (e.g. the copper-substituted zeolite as described herein) such that they are present as counter-ions at the ion exchange sites of the framework structure. The rare earth element(s) may be present as an extra-framework element, which is one that resides within the zeolite and/or on at least a portion of the zeolite surface, does not include aluminum, and does not include atoms constituting the framework of the molecular sieve. The rare earth element can be added to the zeolite (e.g. the copper-substituted zeolite as described herein) via any known technique such as ion exchange, spray drying, and cold one pot, etc. Preferably the rare earth element is incorporated through ion exchange.

The method of preparing a catalyst composition may include incorporating a rare earth element into a zeolite (e.g. the copper-substituted zeolite as described herein) through ion exchange. The ion exchange may be conducted by blending the zeolite (e.g. the copper-substituted zeolite as described herein) into a solution containing soluble precursors of the rare earth element(s). The pH of the solution may be adjusted to induce precipitation of the catalytically active rare earth element cations onto or within the zeolite structure. For example, a zeolite (e.g. the copper-substituted zeolite as described herein) is immersed in a solution containing a soluble precursor of the rare earth element(s) for a time sufficient to allow incorporation of the catalytically active rare earth cation(s) into the molecular sieve structure by ion exchange. Unexchanged rare earth ions can be precipitated out. Depending on the application, a portion of the unexchanged ions can remain in zeolite material as free metals. The rare-earth-substituted zeolite may then be washed, dried and calcined. In a preferred alternative embodiment, the resulting rare-earth-substituted zeolite is used directly to form a washcoat.

In a particular embodiment, a zeolite (e.g. the copper-substituted zeolite as described herein) is immersed in a solution containing cerium acetate or cerium carbonate for a time sufficient to allow incorporation of the catalytically active cerium cations into the molecular sieve structure by ion exchange. Unexchanged cerium ions can be precipitated out. Depending on the application, a portion of the unexchanged ions can remain in zeolite material as free cerium. The cerium-substituted zeolite may then be washed, dried and calcined. In a preferred alternative embodiment, the resulting cerium-substituted zeolite is used directly to form a washcoat.

Generally, incorporation of the rare earth element(s) into or on the zeolite to form a catalyst composition may be carried out at room temperature or at a temperature up to about 80° C. For example, incorporation of the rare earth element(s) can be carried out at a temperature of from 15 to 80° C., e.g. from 18 to 70° C., from 20 to 60° C., from 21 to 50° C., from 22 to 40° C., or from 25 to 30° C. In a preferred embodiment, incorporation of the rare earth element(s) is carried out at room temperature (e.g. a temperature from 15-30° C., 16-28° C., 17-25° C., 18-23° C. or from 19-21° C.). Ion exchange can be performed over a period of about 1 to 24 hours, e.g. from 2 to 22 hours, from 3 to 20 hours, from 4 to 15 hours, or from 5 to 10 hours. Ion exchange can be performed at a pH of less than 9, e.g. less than 8, less than 7, less than 6, less than 5, less than 4 or less than 3. In a preferred example, the pH of the ion exchange is between 2 and 5 or between 3 and 4.

In an alternative embodiment, the zeolite is combined with water and a copper source (e.g. copper carbonate) is added. The resulting mixture is left for a suitable time period (e.g. between 1 and 24 hours, e.g. from 2 to 22 hours, from 3 to 20 hours, from 4 to 15 hours, or from 5 to 10 hours) at room temperature (e.g. from 15-25° C., 16-24° C., 17-23° C., 18-22° C. or from 19-21° C.). The rare earth element can then be added (e.g. in the form of a rare earth salt such as cerium acetate or cerium carbonate) to form a catalyst composition.

The catalyst composition as described herein can then be formulated in a washcoat. In addition to the catalyst composition, the washcoat composition can further comprise (i) one or more binders selected from the group comprising (e.g. consisting of) alumina, silica, (non zeolite) silica-alumina, naturally occurring clays, TiO₂, ZrO₂, and SnO₂, and/or (ii) one or more rheology modifiers (e.g. rheology modifiers such as Natrosol, TEAOH (tetraethylammonium hydroxide), Dispex or ammonia).

The washcoat can be applied to a substrate, such as a metal or ceramic flow through monolith substrate or a filtering substrate, e.g. one including for example a wall-flow filter or sintered metal or partial filter. The resulting coated substrate is preferably dried and calcined. Preferably, the coated substrate is dried at about 100 to 120° C. Preferably, the coated substrate is dried for 15 min to 2 hours, e.g. from 20 min to 1 hour. The dried coated substrate can then be calcined at a temperature of from 400 to 800° C., preferably from 450 to 750° C., e.g. around 500° C.

Catalyst Article In a further aspect of the invention, herein provides a catalyst article for an exhaust gas, wherein the catalyst article comprises the catalyst composition as described herein or obtained by the method as described herein.

The catalyst composition (e.g. the catalyst composition as described herein) can be in the form of a washcoat, preferably a washcoat that is suitable for coating a substrate, such as a metal or ceramic flow through monolith substrate or a filtering substrate, e.g. one including for example a wall-flow filter or sintered metal or partial filter. Accordingly, another aspect of the invention is a washcoat comprising a catalyst composition as described herein. In addition to the catalyst composition, washcoat compositions can further comprise one or more binders selected from the group comprising (e.g. consisting of) alumina, silica, (non zeolite) silica-alumina, naturally occurring clays, TiO₂, ZrO₂, and SaO₂. A further aspect of the invention is a catalyst article comprising a substrate and a catalyst composition as described herein, which may be applied as a washcoat.

Preferred substrates for use are monoliths having a so-called honeycomb geometry which comprises a plurality of adjacent, parallel channels, each channel typically having a square cross-sectional area. The honeycomb shape provides a large catalytic surface with minimal overall size and pressure drop. The catalyst composition can be deposited on a flow-through monolith substrate (e.g., a honeycomb monolithic catalyst support structure with many small, parallel channels running axially through the entire part) or filter monolith substrate such as a wall-flow filter, etc. In another embodiment, the catalyst composition is formed into an extruded-type catalyst. Preferably, the catalyst composition is coated on a substrate in an amount sufficient to reduce the NOx contained in an exhaust gas stream flowing through the substrate. In certain embodiments, at least a portion of the substrate may also contain a platinum group metal, such as platinum (Pt), to oxidize ammonia in the exhaust gas stream or perform other functions such as conversion of CO into CO₂.

The catalyst article as described herein preferably comprises a honeycomb monolith body comprising a catalyst composition (e.g. the catalyst composition as described herein), preferably as a washcoat layer thereon.

### Exhaust Gas System and Method

According to a further aspect there is provided an exhaust gas system comprising the catalyst article described herein and, optionally, a combustion engine. The combustion engine can be a diesel engine, a lean-burn gasoline engine or an engine powered by liquid petroleum gas or natural gas. Preferably, the combustion engine is a diesel engine. The catalyst article can be arranged downstream of the engine to treat the exhaust gas emitted therefrom.

According to a yet further aspect of the invention, there is provided a method for the treatment of an exhaust gas, the method comprising contacting the exhaust gas with the catalyst article as described herein.

Although preferred embodiments of the invention have been described herein in detail, it will be understood by those skilled in the art that variations may be made thereto without departing from the scope of the invention or of the appended claims.

The invention will now be described further in relation to the following non-limiting examples and figures.

### EXAMPLES

### General Method

A zeolite, ZEO (CHA zeolite with a SAR of 14) or ZEO2 (CHA zeolite with a SAR of 23) was combined with water, and copper acetate was added to the reaction mixture. The reaction mixture was heated to 70° C. for 4 hours. The reaction mixture was allowed to cool and water-dispersible boehmite alumina was then added, followed by cerium acetate, and then followed by the addition of natrosol and the pH was adjusted with TEAOH to >3.8.

### Example 1—Varying Cu and Rare Earth Loadings

Cu-zeolite catalysts were prepared by impregnating a zeolite powder with a Cu(II) Acetate solution to achieve Cu loadings of between 2 wt % and 5.5 wt %. Ce was incorporated into the Cu-zeolite catalysts to achieve loadings varying from 25 g/ft³ to 200 g/ft³. The total washcoat loading was varied from 2.4 up to 3 On′.

The following catalysts were prepared:

| | Cu loading | | Ce | Total washcoat |
|---|---|---|---|---|
| Cat | (wt %) | Zeolite | loading | loading (g/in³) |
| 1 | 4 | CHA (SAR = 14) | 125 g/ft³ | 3 |
| 2 | 4.75 | CHA (SAR = 14) | — | 3 |
| 3 | 4.75 | CHA (SAR = 14) | 68 g/ft³ | 3 |
| 4 | 4.75 | CHA (SAR = 14) | 125 g/ft³ | 3 |
| 5 | 4.75 | CHA (SAR = 14) | 188 g/ft³ | 3 |
| 6 | 5.25 | CHA (SAR = 14) | — | 3 |
| 7 | 5.25 | CHA (SAR = 14) | 68 g/ft³ | 3 |
| 8 | 5.25 | CHA (SAR = 14) | 125 g/ft³ | 3 |
| 9 | 5.25 | CHA (SAR = 14) | 188 g/ft³ | 3 |
| 10 | 5.5 | CHA (SAR = 14) | — | 3 |
| 11 | 5.5 | CHA (SAR = 14) | 68 g/ft³ | 3 |
| 12 | 5.5 | CHA (SAR = 14) | 125 g/ft³ | 3 |
| 13 | 5.5 | CHA (SAR = 14) | 188 g/ft³ | 3 |
| 14 | 4.75 | CHA (SAR = 14) | 4.3 wt % | 2.4 |
| 15 | — | CHA (SAR = 14) | — | 2.4 |
| 16 | 3.33 | CHA (SAR = 23) | — | |
| 17 | 3.33 | CHA (SAR = 23) | 2.3 wt % | |
| 18 | 4 | CHA (SAR = 14) | — | |
| 19 | 4 | CHA (SAR = 14) | 2.8 wt % | |
| 20 | 4.75 | CHA (SAR = 14) | — | |
| 21 | 4.75 | CHA (SAR = 14) | 4.3 wt % | |

### SCAT Testing

Scat testing was evaluated at four temperature points (175, 200, 250 and 600° C.) with a temperature ramp of 600° C. between each stage. During the test, 500 ppm NOx was evaluated at 1.5 ALPHA. The tests were run for a set amount of time or until 20 ppm slip of ammonia occurs, whichever was first.

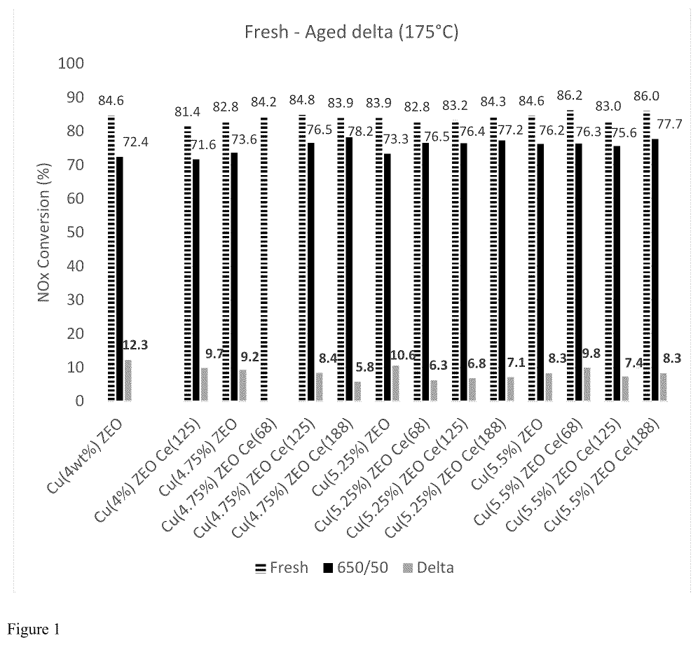

The NOx conversions, N₂O selectivities, and NH₃ storage were evaluated at the four temperature points. The results are shown in FIG. 1.

FIG. 1 shows the effect of different ceria loadings and different copper loadings for fresh and aged (650° C. for 50 h). The optimum results were for Cu(4.75%) ZEO Ce (188 g/ft³) for performance delta. Cu(4 wt %) ZEO is a reference example which is ZEO with 4 wt % Cu loading. ZEO is a CHA zeolite framework with a SAR of 14.

### Example 2—Varying the Loading of Sulfur

Sulfur loading/doping was carried out on a synthetic gas bench rig by subjecting a fully coated SCR ceramic monolith catalyst sample (1×3″) to a defined cycle of SO₂ ageing gas mix (Table 1) a pre-determined number of times with a Pt-based DOC (1×1″) upstream of the SCR catalyst in question. Each sulfation “SOx cycle” consisted of a ramp to 525° C., cooling to 200° C., then cycling between 200-350° C. three times where SO₂ injection took place only during the cycling phase, to target approximately 0.45 g/L of sulfur exposure per cycle. Prior to the pre-determined number of “SOx cycles” subjected to each catalyst sample, the actual sulfur exposure during each “SOx cycle” was calculated by using a blank core as a sulfur-inlet check on the ageing-gas mix with a target of 7.5 ppm SO₂.

TABLE 1
SO₂ Ageing gas mix

| Gas | Concentration |
|---|---|
| NO | 100 ppm |
| NH₃ | 0 ppm |
| SO₂ | 7.5 ppm |
| O₂ | 10% |
| H₂O | 5% |
| CO₂ | 8% |
| N₂ | Balance |

### SCR Performance Evaluation Post Sulfation Testing

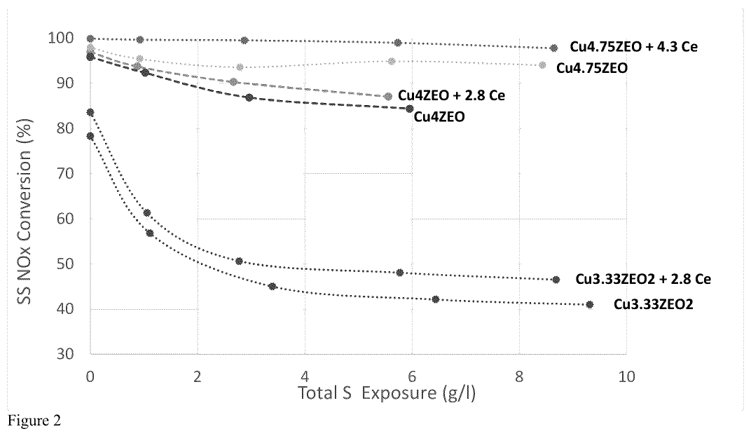

After a pre-defined number of “SOx cycles” with known Sulfur exposure/loading via SO₂ inlet checks (as described above), an SCR performance evaluation test was carried out on SCAT with only the “loaded”-SCR sample in question using the SCR Evaluation gas mixture (Table 2). The SCR performance test consists of a ramp to a set temperature (450, 500, 530° C.) with cooling and holding at 200° C. after each ramp and evaluation in the SCR evaluation gas mix at the held 200° C. until 20 ppm NH₃ slip occurs. The results are shown in FIG. 2. ZEO2 is a CHA zeolite with a SAR of 23.

TABLE 2
SCR evaluation gas mixture

| Gas | Concentration |
|---|---|
| NO | 500 ppm |
| NH₃ | 750 ppm |
| CO | 350 ppm |
| O₂ | 10% |
| H₂O | 5% |
| CO₂ | 8% |
| N₂ | Balance |

FIG. 2 shows the Cu SCR sulfur ageing with various different catalyst compositions. This figure shows that addition of a rare earth element improves the sulfur tolerance and hydrothermal ageing.

1. A catalyst composition comprising:
a) a low SAR zeolite;
b) copper in an amount of at least 2 wt %; and
c) a rare earth element.

2. The catalyst composition of claim 1, wherein the zeolite has a SAR of between 10 and 25.

3. The catalyst composition of claim 1, wherein the zeolite has a SAR of between 11 to 21.

4. The catalyst composition of claim 1, wherein the copper is present in an amount of at least 2.5 wt %.

5. The catalyst composition of claim 1, wherein the copper is present in an amount of at least 3 wt %.

6. The catalyst composition of claim 1, wherein the copper is present in an amount of at least 4 wt %.

7. The catalyst composition of claim 1, wherein the rare earth element is selected from the group comprising La, Ce, Pr, Nd, Sm, Eu, Gd, Tb, Dy, Ho, Er, Tm, Yb, Lu, Y, and Sc.

8. The catalyst composition of claim 1, wherein the rare earth element is present in an amount of from 2 to 5 wt %.

9. The catalyst composition of claim 1, wherein the rare earth element is present in an amount of from 2.75 to 4.5 wt %.

10. The catalyst composition of claim 1, wherein the zeolite is a small-pore zeolite.

11. The catalyst composition of claim 10, wherein the small-pore zeolite has a CHA or AEI framework structure type.

12. A method of preparing a catalyst composition of claim 1, the method comprising:
(i) incorporating copper into a zeolite to prepare a copper-substituted zeolite, and
(ii) incorporating a rare earth element into the copper-substituted zeolite.

13. A catalyst article for an exhaust gas system, the catalyst article comprising a substrate and the catalyst composition of claim 1.

14. An exhaust gas system comprising the catalyst article of claim 13 and a combustion engine.

15. A method for the treatment of an exhaust gas, the method comprising contacting an exhaust gas with the catalyst article according to claim 13.
